(19) United States
(12) Patent Application Publication
(10) Pub. No.: US 2007/0246957 A1
(43) Pub. Date: Oct. 25, 2007

(54) LOADING DEVICE OF LOADING A SUBSTRATE CAPABLE OF ELIMINATING ELECTROSTATIC CHARGES

(76) Inventors: Yi-Cheng Liu, Tao-Yuan Hsien (TW); Hsin-Hsiung Wang, Taipei City (TW); Ming-Kang Huang, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/380,205

(22) Filed: Apr. 25, 2006

(51) Int. Cl. B65G 49/07

(52) U.S. Cl. 294/1.1

(57) ABSTRACT

A loading device for loading a substrate includes: a support module having at least a contact region contacted with the substrate for providing a supporting force to load the substrate; and a conductive media, electrically connected to the contact region and a voltage level, for eliminating electrostatic discharges between the contact region and the substrate.

### BACKGROUND OF THE INVENTION

1. Field of the Invention

The invention relates to a loading device of loading a substrate, and more particularly, to a loading device capable of eliminating electrostatic charges.

2. Description of the Prior Art

In the fields of semiconductor manufacturing processes, each substrate, also commonly referred to as a wafer, is processed through multiple manufacturing processes to produce a variety of electronic products. Taking the liquid crystal display (LCD) as an example, a glass substrate is processed through various complex manufacturing processes. These processes include: exposure, development, and deposition processes such that the LCD can be formed. The above-mentioned complex processes should be performed by different machines. Therefore, in the entire flow of manufacturing processes that are necessary to generate the LCD, the glass substrate must be moved to a specific machine to perform current manufacturing processes according to the required manufacturing flow.

However, in the process of locating the glass substrate inside the clean room, electrostatic charges are formed on the glass substrate. This is especially apparent during the moving process. The electrostatic charges form regardless of steps taken such as placing the glass substrate in a cassette or placing it in a moving/loading device such as a vacuum robot or an operating machine. Regardless of these prevention efforts, the electrostatic charges are formed on the glass substrate because the glass substrate still has frictions with surrounding environments. Therefore, the electrostatic discharge (ESD) effect occurs.

For some specific machines, for example, the ULVAC PVD machine, the vacuum robot forklift is firstly utilized to move the glass substrate to the sputter chamber. Then the PVD process is performed on the glass substrate to form the thin film of semiconductor and protection layer on the surface of the glass substrate.

Please refer to FIG. 1, which is a diagram of a conventional robot forklift 100. As shown in FIG. 1, the robot forklift 100 comprises support modules 110, 120, and a connect module 130. The connect module 130 is connected to the body of the robot. The support modules 110, 120 are connected to the connect module 130 such that the connecting force between the support modules 110, 120 and the connect module 130 can be utilized to provide a support force to the support modules 110, 120. Therefore, the support modules 110, 120 can be utilized to load the glass substrate 150 such that the glass substrate 150 can be moved to different machines by the robot forklift 100.

In addition, each of the support modules 110, 120 comprises a plurality of pads 140. When the support modules 110, 120 move the glass substrate 150, the pads 140 provide the glass substrate 150 with a plurality of contact regions such that the pads 140 can provide needed supporting force for loading the glass substrate 150 through these contact regions. Furthermore, the pads 140 can also provide friction to the glass substrate 150 in order to prevent the glass substrate 150 from sliding.

Because these pads 140 rub against the glass substrate 150, the electrostatic charges are accumulated between the glass substrate 150 and pads 140. If the electrostatic charges are accumulated to be larger than a threshold, the above-mentioned ESD effect occurs between the glass substrate 150 and the pads 140. Therefore, the above-mentioned ESD effect occurs in the areas 160, 170. It is well known that the ESD effect changes the electric fields in the areas 160, 170. The manufacturing processes are influenced by unstable electric fields resulting in errors. This directly decreases the yield of the LCD.

### SUMMARY OF THE INVENTION

It is therefore one of the primary objectives of the invention to provide a loading device capable of eliminating electrostatic charges, to solve the above-mentioned problem.

The present invention discloses a loading device for loading a substrate. The loading device comprises a support module and a conductive media. The support module comprises at least one contact region contacted with the substrate for providing a supporting force to load the substrate. As mentioned previously, ESD effect may occurs on the contact region. Therefore, the conductive media is electrically connected to the contact region and a voltage level for eliminating electrostatic charges between the contact region and the substrate.

In addition, the present invention further discloses a method for utilizing a loading device to load a substrate. The method comprises: utilizing at least a contact region on a support module to contact the substrate such that a supporting force is provided to the substrate to load the substrate; and electrically connecting the contact region to a voltage level such that electrostatic charges between the contact region and the substrate are eliminated.

The present invention robot forklift comprises a conductive media to eliminate the electrostatic charges between the pads and the glass substrate. Therefore, the interferences by the electrostatic charges can be reduced and the yield of the LCD can be increased.

### BRIEF DESCRIPTION OF THE DRAWINGS

FIG. 1 is a diagram of a conventional robot forklift.

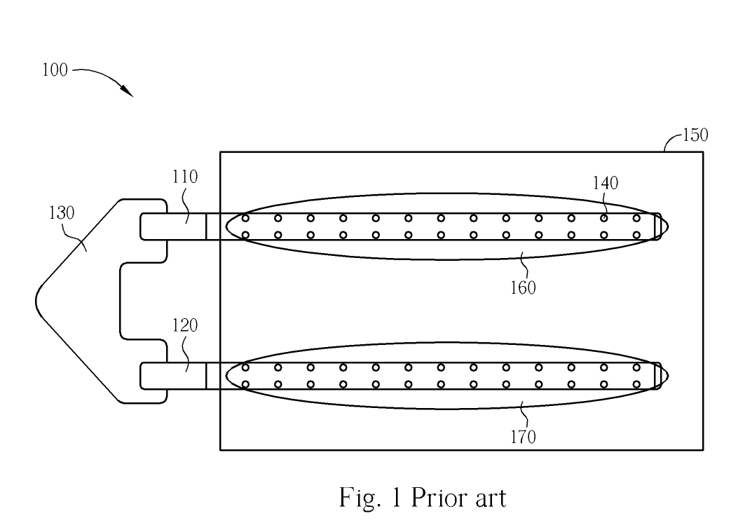

FIG. 2 is a diagram of a robot forklift according to the present invention.

FIG. 3 is a diagram of a conductive media shown in FIG. 2 of an embodiment according to the preset invention.

### DETAILED DESCRIPTION

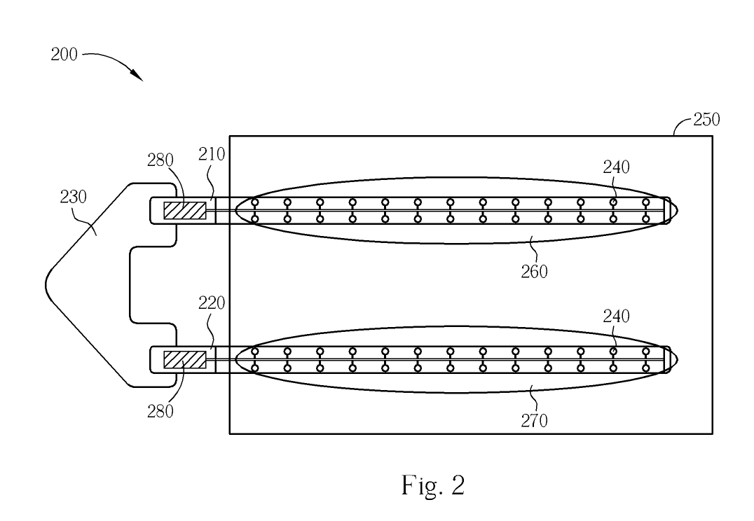

Please refer to FIG. 2, which is a diagram of a robot forklift 200 according to the present invention. As shown in FIG. 2, the robot forklift 200 also comprises support modules 210, 220, and a connect module 230. The connect module 230 is connected to the body of the robot. The support modules 210, 220 are connected to the connect module 230 such that the connecting force between the support modules 210, 220 and the connect module 230 can be utilized to provide a support force to the support modules 210, 220. Therefore, the support modules 210, 220 can be utilized to load the glass substrate 250 such that the glass substrate 250 can be moved to different machines by the robot forklift 200.

Similar to the robot forklift 100, each of the support modules 210, 220 of the present invention robot forklift 200 also comprises a plurality of pads 240. When the support modules 210, 220 move the glass substrate 250, the pads 240 provide the glass substrate 250 with a plurality of contact regions such that the pads 240 can provide the needed support force for loading the glass substrate 250 through these contact regions. Furthermore, the pads 240 can also provide frictions to the glass substrate 250 in order to prevent the glass substrate 250 from sliding.

In this embodiment, each of the support modules 210, 220 further comprises a conductive media 280. One end of the conductive media 280 is electrically connected to the above-mentioned pads 240, and the other end of the conductive media 280 is electrically connected to a ground voltage. Therefore, the aforementioned electrostatic charges in the areas 260, 270 are removed by the ground voltage through the conductive media 280. Therefore, the above-mentioned ESD effect can be sufficiently eliminated.

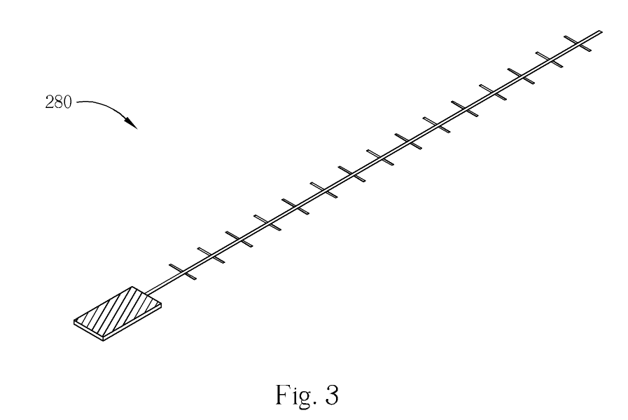

Please refer to FIG. 3, which is a diagram of the conductive media 280 shown in FIG. 2 of an embodiment according to the present invention. As shown in FIG. 3, the conductive media 280 is a tree-shaped copper film conductive line. Moreover, each branch of the conductive media 280 is contacted to the pads 240 of the support modules 210, 220, and the other end of the conductive media 280 is electrically connected to the ground voltage. Therefore, the electrostatic charges can be removed by the ground voltage. Please note the tree-shaped copper film conductive line 280 is only utilized as a preferred embodiment; this is not a limitation of the present invention. In other words, the conductive media 280 can have various shapes or can be manufactured utilizing other conducting materials. This change also obeys the spirit of the present invention.

However, in the preferred embodiment of the present invention, sufficiently removes the electrostatic charges between the pads 240 and the glass substrate 250 by utilizing some components that are refined to optimize the removing operation of the electrostatic charges. For example, the pads 240 are manufactured by tiny electricity-conducting materials. Therefore, the electrostatic charges can be smoothly conducted through pads 240 and conductive media 280. Please note, the pads 240 can also be manufactured utilizing other materials. The above-mentioned tiny electricity-conducting materials are only utilized as a preferred embodiment; this is not a limitation of the preset invention.

Furthermore, please refer to FIG. 2 and FIG. 3 again. The conductive media 280 is pasted on the support modules 210, 220 utilizing a glue. Therefore, for the best mode of the entire structure of the robot forklift 200 and for preventing the conductive media 280 from influencing the original manufacturing processes, in the preferred embodiment, is the glue. The glue is capable of bearing high temperature. Therefore, the glue does not vaporize thus producing unwanted gas that might influence the manufacturing processes. Furthermore, the thickness of the copper thin film 280 is made as thin as possible such that the influence of the copper thin film 280 can be minimized. For example, the thickness of the copper thin film 280 can be 0.1 mm. However, the 0.1 mm thickness and the glue capable of bearing high temperature are also utilized as an embodiment of the present invention. In other words, designers can select various glues and thickness according to various manufacturing procedure and cost requirements. This change also obeys the spirit of the present invention.

Please note, in the above disclosure, the manufacturing process of the LCD is utilized to illustrate the technique of the present invention, however, the preset invention can be utilized in the manufacturing processes of other electronic devices. In other words, the present invention robot forklift is not limited to the task of loading the glass substrate, in fact, the present invention robot forklift can be utilized to load and move all kinds of substrates or wafers.

In addition, the present invention is not limited to be utilized in the above-mentioned robot forklift. In the actual implementation, all loading devices for loading substrates can utilize the present invention method and related structure to remove the electrostatic charges of the substrate. This change also obeys the spirit of the present invention.

In contrast to the prior art, the present invention robot forklift comprises a conductive media to eliminate the electrostatic charges that are formed between the pads and the glass substrate. Therefore, the interference caused by the electrostatic charges can be reduced and the yield of the LCD can be increased.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A loading device for loading a substrate comprising:
a support module having at least one contact region contacted with the substrate for providing a support force to load the substrate; and
a conductive media, electrically connected to the contact region and a voltage level, for eliminating electrostatic charges between the contact region and the substrate.

2. The loading device of claim 1, wherein the support module comprises a plurality of pads, and each of the pads provides a contact region to contact the substrate.

3. The loading device of claim 2, wherein the pads are manufactured utilizing tiny electricity-conducting material.

4. The loading device of claim 1, being utilized in a robot forklift.

5. The loading device of claim 1, wherein the conductive media comprises a metal thin film connected to the contact region.

6. The loading device of claim 5, wherein the metal thin film is a copper thin film.

7. The loading device of claim 6, wherein the copper thin film is pasted onto the support module.

8. The loading device of claim 7, wherein the copper thin film is pasted onto the support module utilizing a glue.

9. The loading device of claim 8, wherein the glue is a glue capable of bearing high temperature.

10. The loading device of claim 1, wherein the substrate is a glass substrate.

11. The loading device of claim 1, wherein the voltage level is a ground voltage level.

12. A method for utilizing a loading device to load a substrate, the method comprising:
utilizing at least a contact region on a support module to contact the substrate such that a support force is provided to the substrate to load the substrate; and
electrically connecting the contact region to a voltage level such that electrostatic charges between the contact region and the substrate are eliminated.

13. The method of claim 12, being utilized in a robot forklift.

14. The method of claim 12, wherein the substrate is a glass substrate.
